(19) United States
(12) Patent Application Publication
(10) Pub. No.: US 2009/0179874 A1
(43) Pub. Date: Jul. 16, 2009

(54) ELECTRONIC APPARATUS

(75) Inventor: Yusuke WATANABE, Matsumoto-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-Shi (JP)

(21) Appl. No.: 12/269,571

(22) Filed: Nov. 12, 2008

(30) Foreign Application Priority Data
Jan. 15, 2008 (JP) 2008-005311

(51) Int. Cl. G06F 3/033

(52) U.S. Cl. 345/184

(57) ABSTRACT

Provided is an electronic apparatus including a plurality of casing bodies which are connected to one another so as to be relatively moved, wherein, by relatively moving the plurality of casing bodies, a first mode in which a first input manipulation unit is positioned on one side of a display unit for displaying information and a second mode in which the first input manipulation unit is positioned on one side of the display unit and a second input manipulation unit is positioned on the other side of the display unit are switched, and wherein an image display in which the first input manipulation unit is positioned on a lower side of the display unit is performed in the first mode and an image display in which the first input manipulation unit and the second input manipulation unit are positioned on left and right sides of the display unit is performed in the second mode.

The entire disclosure of Japanese Patent Application No. 2008-005311, filed Jan. 15, 2008 is expressly incorporated by reference herein.

### BACKGROUND

1. Technical Field

The present invention relates to an electronic apparatus including a display unit and an input manipulation unit included in a plurality of casing bodies which are slidably and/or rotatably connected.

2. Related Art

Recently, an electronic apparatus such as a mobile telephone or a personal digital assistant (PDA) has a plurality of functions in addition to an original function as a processing speed thereof is significantly improved. For example, the mobile telephone has various functions such as a TV telephone function, a camera function, a video filming/displaying function, a game function, a music play function, and a schedule function, in addition to a communication function. When an input manipulation unit is only arranged at a lower position of a vertically elongated display unit, convenience in use of the various functions is decreased.

Accordingly, an electronic apparatus capable of switching the position of an input manipulation unit of a display unit or the direction of the display unit using a sliding mechanism or a hinge mechanism is suggested (for example, see JP-A-2004-312982, JP-A-2005-341025, JP-A-2005-76688, JP-A-2006-313533, JP-A-2005-269566, and JP-A-2007-19680).

However, if the configurations described in JP-A-2004-312982, JP-A-2005-341025, JP-A-2005-76688, JP-A-2006-313533, JP-A-2005-269566, and JP-A-2007-19680 is employed, an image can be readily viewed according to applications, but the manipulation with both hands is not convenient, that is, the inconvenience of the manipulation is not solved. Thus, the convenience needs to be improved.

### SUMMARY

An advantage of some aspects of the invention is that it provides an electronic apparatus capable of facilitating an input manipulation with both hands according to modes.

According to an aspect of the invention, there is provided an electronic apparatus including a plurality of casing bodies which are connected to one another so as to be relatively moved, wherein, by relatively moving the plurality of casing bodies, a first mode in which a first input manipulation unit is positioned on one side of a display unit for displaying information and a second mode in which the first input manipulation unit is positioned on one side of the display unit and a second input manipulation unit is positioned on the other side of the display unit are switched, and wherein an image display in which the first input manipulation unit is positioned on a lower side of the display unit is performed in the first mode and an image display in which the first input manipulation unit and the second input manipulation unit are positioned on left and right sides of the display unit is performed in the second mode.

In the electronic apparatus according to the invention, in the first mode, the first input manipulation unit positioned one side of the display unit for displaying the information and the image display in which the first input manipulation unit is positioned on a lower side of the display unit is performed. In the invention, the second mode in which the first input manipulation unit and the second input manipulation unit are positioned on the both sides of the display unit is realized, and the image display in which the first input manipulation unit and the second input manipulation unit are positioned on left and right sides of the display unit is performed in the second mode. Accordingly, in the second mode, the first input manipulation unit and the second input manipulation unit can be manipulated by the both hands of the user while viewing the image displayed by the display unit and thus a manipulation property when the game function and the like are used is excellent.

In the invention, three casing bodies or two casing bodies may be used.

In the invention, if three casing bodies are used, as the plurality of casing bodies, a first casing body in which the first input manipulation unit is formed on the surface thereof, a second casing body in which the second input manipulation unit is formed on the surface thereof, and a third casing body in which the display unit is formed on the surface thereof may be included, in the first mode, the third casing body may be arranged on the surface of the second casing body so as to overlap with the second casing body in a state in which the third casing body exposes the first input manipulation unit such that the surface of the second input manipulation unit is covered, and when the first mode is switched to the second mode, the third casing body may be moved to one side of the second casing body in a state in which the first input manipulation unit is exposed such that the surface of the second input manipulation unit is exposed. By this configuration, since the third casing body covers the surface of the second casing body in the first mode, the size of the electronic apparatus may be reduced in the first mode.

If this configuration is employed, the first casing body and the second casing body are moved relative to the third casing body such that switching is performed between a standby mode in which the first casing body and the second casing body overlap with the third casing body in a thickness direction and the first mode. By this configuration, it is possible to minimize the size of the electronic apparatus in the standby state.

In the invention, in the case where the three casing bodies are used and the standby mode is set, the end of the other side of the first casing body may be connected to the end of one side of the second casing body via a hinge mechanism, the third casing body may be connected to the second casing body on the surface of the second casing body via a sliding mechanism, in the standby mode, the second casing body and the third casing body may overlap with the first casing body on the surface of the first casing body, the switch from the standby mode to the first mode may be performed by rotating the second casing body and the third casing body to the other side of the first casing body in a state of overlapping with each other by the hinge mechanism and exposing the surface of the first casing body and the surface of the third casing body, and the switch from the first mode to the second mode may be performed by sliding the third casing body toward the first casing body on the surface of the second casing body by the sliding mechanism so as to cover a portion of the surface of the first casing body and opening the other side of the surface of the second casing body.

In the invention, in the case where the three casing bodies are used and the standby mode is set, the first casing body may be connected to the third casing body on the rear surface of the third casing body via a first sliding mechanism, the second casing body may be connected to the third casing body on the rear surface of the third casing body via a second sliding mechanism, in the standby mode, the first casing body and the second casing body may overlap with the third casing body on the surface of the third casing body, the switch from the standby mode to the first mode may be performed by sliding only the first casing body to one side of the third casing body by the first sliding mechanism and exposing the surface of the first casing body, and the switch from the first mode to the second mode may be performed by sliding the second casing body to the other side of the third casing body by the second sliding mechanism and exposing the surface of the second casing body.

In the invention, in the case where the three casing bodies are used and the standby mode is set, the first casing body may be connected to the third casing body on the rear surface of the third casing body via a first sliding mechanism, the second casing body may be connected to the third casing body via a second sliding mechanism in a state of being received in the third casing body, in the standby mode, the first casing body may be arranged on the rear surface of the third casing body so as to overlap with the third casing body and the second casing body is received in the third casing body, the switch from the standby mode to the first mode may be performed by sliding only the first casing body to one side of the third casing body by the first sliding mechanism and exposing the surface of the first casing body, and the switch from the first mode to the second mode may be performed by sliding the second casing body to the other side of the third casing body by the second sliding mechanism and exposing the surface of the second casing body.

In the invention, in the case where two casing bodies are used, as the plurality of casing bodies, a first casing body in which the first input manipulation unit and the display unit are respectively formed in the region of one side and the region of the other side of the surface thereof and a second casing body in which the second input manipulation unit is formed on the surface thereof may be included, in the first mode, the first casing body may be arranged on the second casing body so as to overlap with the second casing body and the second input manipulation unit is covered by the first casing body, and, when the first mode is switched to the second mode, the surface of the second casing body may be exposed by relatively moving the first casing body to one side of the second casing body.

For example, the second casing body may be connected to the first casing body on the rear surface of the first casing body via a sliding mechanism, and the switch from the first mode to the second mode may be performed by sliding the second casing body to the other side of the first casing body by the sliding mechanism and exposing the surface of the second casing body.

In the invention, a third input manipulation unit may be formed on the surface of the second casing body in the region of one side of the second input manipulation unit, in the standby mode, the second casing body may overlap with the first casing body in a thickness direction and the second input manipulation unit and the third input manipulation unit may be covered by the first casing body, and, when the standby mode is switched to the first mode, the third input manipulation unit may be exposed at one side of the first manipulation unit. By this configuration, since the third input manipulation unit is positioned at a position adjacent to the first input manipulation unit in the first mode, the first input manipulation unit requires only the number of buttons necessary for the second mode and thus the first input manipulation unit can be downsized.

In the invention, the electronic apparatus may further include a sensor which detects the switch between the first mode and the second mode, and, on the basis of the detecting result of the sensor, the direction of an image displayed by the display unit may be automatically switched between the first mode and the second mode.

In the invention, the display unit may display a selection screen of an application, which is expected to be used in the second mode, in the second mode on the basis of the detecting result of the sensor.

In the invention, at least one of the first input manipulation unit and the second input manipulation unit may be configured by a display device attached with an input function, and, in the second mode, the shape of manipulation buttons displayed by the display device attached with the input function may be switched on the basis of the input manipulation of the first input manipulation unit or/and the second input manipulation unit. By this configuration, since the manipulation buttons suitable for the application used in the second mode are arranged with respect to the input manipulation unit configured by the display device having the input function, high convenience for use is achieved.

### BRIEF DESCRIPTION OF THE DRAWINGS

The invention will be described with reference to the accompanying drawings, wherein like numbers reference like elements.

FIG. 1 is a view showing the shapes of an electronic apparatus according to Embodiment 1 of the invention in a standby mode, a first mode and a second mode.

FIGS. 2A and 2B are views showing an image displayed in a first mode and an image displayed in a second mode, respectively, in a display unit of the electronic apparatus according to the invention.

FIGS. 3A and 3B are views showing a hinge mechanism and a sliding mechanism included in the electronic apparatus according to the invention, respectively.

FIG. 4 is a block diagram showing the configuration of a mode controller included in the electronic apparatus according to the invention.

FIGS. 5A, 5B and 5C are views showing the shapes of an electronic apparatus according to Embodiment 2 of the invention in a standby mode, a first mode and a second mode.

FIGS. 6A, 6B and 6C are views showing the shapes of an electronic apparatus according to Embodiment 3 of the invention in a standby mode, a first mode and a second mode.

FIGS. 7A and 7B are views showing the shapes of an electronic apparatus according to Embodiment 4 of the invention in a first mode and a second mode.

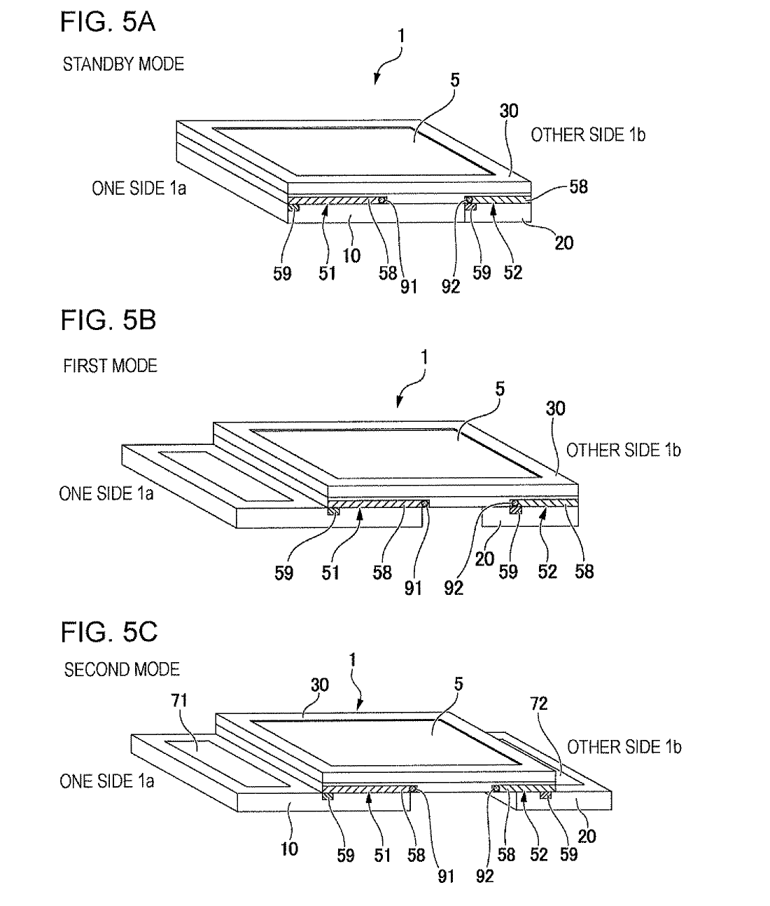

FIGS. 5A, 5B and 5C are views showing the shapes of an electronic apparatus according to Embodiment 5 of the invention in a standby mode, a first mode and a second mode.

FIGS. 9A and 9B are views showing a selection screen of pressing buttons displayed by the display unit and the pressing buttons displayed by the selection, in an electronic apparatus according to a modified example of Embodiments 1 to 5 of the invention.

### DESCRIPTION OF EXEMPLARY EMBODIMENTS

Hereinafter, an electronic apparatus according to the invention will be described with reference to the accompanying drawings.

### Embodiment 1

### Whole Configuration

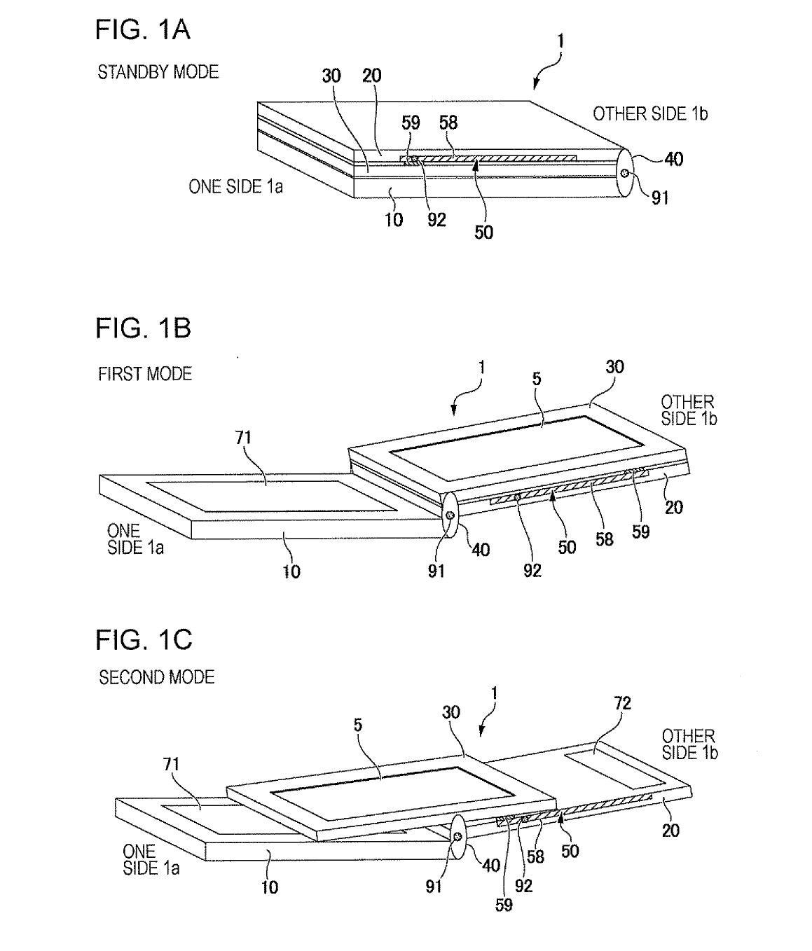

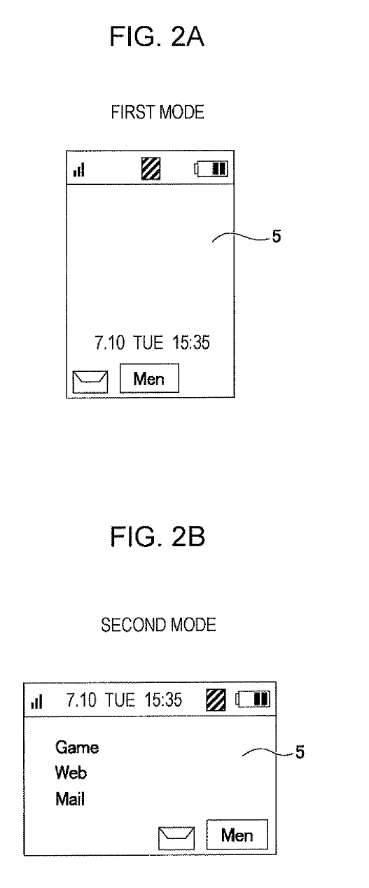

FIGS. 1A, 1B and 1C are views showing the shapes of an electronic apparatus according to Embodiment 1 of the invention in a standby mode, a first mode and a second mode. FIGS. 2A and 2B are views showing an image displayed in a first mode and an image displayed in a second mode, respectively, in a display unit of the electronic apparatus according to the invention.

The electronic apparatus 1 shown in FIGS. 1A, 1B and 1C is a mobile terminal having various functions such as a communication function, a TV telephone function, a camera function, a video filming/displaying function, a game function, a music play function, and a schedule function, of which the shape is changed according to functions.

First, the electronic apparatus 1 of the present embodiment includes a plurality of casing bodies which are connected to one another so as to be relatively moved. By relatively moving these casing bodies, the standby mode shown in FIG. 1A, the first mode shown in FIG. 1B and the second mode shown in FIG. 1C are executed. Among these modes, in the first mode shown in FIG. 1B, a first input manipulation unit 71 is positioned on one side 1a of a display unit 5 including a liquid crystal device or an organic electroluminescence device for displaying information and, in the second mode shown in FIG. 1C, the first input manipulation unit 71 is positioned on one side 1a of the display unit 5 and a second input manipulation unit 72 is positioned on the other side 1b of the display unit 5.

In correspondence with the switch of the mode, in the display unit 5, as shown in FIG. 2A, a vertically long display in which the first input manipulation unit 71 is positioned on a lower side of the display unit 5 is performed in the first mode and, as shown in FIG. 2B, a horizontally long display in which the first input manipulation unit 71 and the second input manipulation unit 72 are positioned in left and right sides of the display unit 5 is performed in the second mode. In the second mode, a selection screen of an application which is expected to be used in the second mode, for example, a text “Game” for selecting the game function, a text “Web” for selecting the Internet function and a text “Mail” for selecting the mail function are displayed by the display unit 5. This selection is performed the manipulation of the first input manipulation unit 71 or/and the second input manipulation unit 72 and the application corresponding to the selected function can be executed.

Accordingly, in the electronic apparatus 1 of the present embodiment, the communication function of the mobile terminal can be used in the first mode similar to the existing mobile telephone, and the first input manipulation 71 and the second input manipulation 72 can be manipulated by both hands of a user while viewing an image displayed by the display unit 5 when the game function, the internet function and the mail function are used in the second mode. Thus, a manipulation property is excellent.

In order to realize these modes, in the present embodiment, three casing bodies including a first casing body 10, a second casing body 20 and a third casing body 30 shown in FIG. 1 are used, and the three casing bodies (the first casing body 10, the second casing body 20 and the third casing body 30) have the substantially same size. In the standby mode shown in FIG. 1A, the first casing body 10 and the second casing body 20 completely overlap with the third casing body 30 in a thickness direction.

First, in the present embodiment, the three casing bodies include the first casing body 10 in which the first input manipulation unit 71 is formed on the substantially whole surface thereof, the second casing body 20 in which the second input manipulation unit 72 is formed on an end of the other side 1b of the surface thereof, and the third casing body 30 in which the display unit 5 is formed on the substantially whole surface thereof. The end of the other side 1b of the first casing body 10 and the end of one side 1a of the second casing body 20 are connected with a hinge mechanism 40 interposed therebetween, and the third casing body 30 is connected to the second casing body 20 with a sliding mechanism 50 interposed therebetween on the surface of the second casing body 20.

In the present embodiment, both the first input manipulation unit 71 and the second input manipulation unit 72 are pressing manipulation units. As described later with reference to FIG. 9, the first input manipulation unit 71 or/and the second input manipulation unit 72 may be configured by a display device including an input function configured by a touch panel on the surface of a display device such as a liquid crystal device or an organic electroluminescence device. In the first input manipulation unit 71 or/and the second input manipulation unit 72, a touch panel may be arranged on a sheet on which pressing buttons are printed.

In the electronic apparatus 1 having the above-described configuration, in the standby mode shown in FIG. 1A, the second casing body 20 and the third casing body 30 are arranged on the first casing body 10 such that the surfaces thereof overlap with the first casing body 10.

The switch from the standby mode to the first mode shown in FIG. 1B is performed by rotating the second casing body 20 and the third casing body 30 by the hinge mechanism 40 toward the other side 1b of the first casing body 10 in a state of overlapping with each other such that the surface of the first casing body 10 and the surface of the third casing body 30 are exposed. As a result, the first input manipulation unit 71 is positioned on one side 1a of the display unit 5. When an operation opposite to this operation is performed, the switch from the first mode to the standby mode is performed.

The switch from the first mode to the second mode shown in FIG. 1C is performed by sliding the third casing body 30 on the surface of the second casing body 20 toward the first casing body 10 by the sliding mechanism 50 so as to cover a portion of the surface of the first casing body 10 and to expose the second input manipulation unit 72 formed on the end of the other side 1b of the surface of the second casing body 20. When an operation opposite to this operation is performed, the switch from the second mode to the first mode is performed. In the second mode, only the portion of the first input manipulation unit 71 is exposed, but all pressing buttons necessary for the second mode are arranged in this portion.

### Configuration Example of Hinge Mechanism and Sliding Mechanism

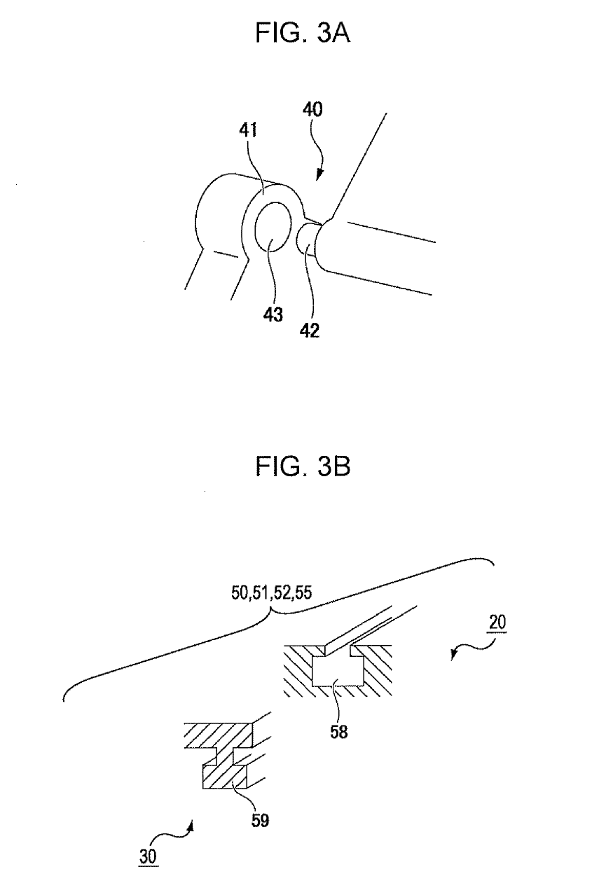

FIGS. 3A and 3B are views showing the hinge mechanism and the sliding mechanism included in the electronic apparatus 1 according to the invention, respectively.

In the electronic apparatus 1 shown in FIG. 1, the hinge mechanism 40 may include bearings 41 formed on the both ends of the first casing body 10 and shafts 42 formed on the both ends of the second casing body 20, as shown in FIG. 3A. The shafts 42 are fitted into shaft holes 43 of the bearings 41 such that the second casing body 20 can be rotated. In the shaft holes 43, the electrical connection between the first casing body 10 and the second casing body 20 are performed. A stopper (not shown) for defining an allowable rotation range of the second casing body 20 is formed using the hinge mechanism 40. In the present embodiment, the second casing body 20 is stopped at about 180 degrees or less, for example, about 170 degrees, with respect to the first casing body 10. A lock mechanism (not shown) for preventing the second casing body 20 from being carelessly rotated to be closed with respect to the hinge mechanism 40 is interposed between the first casing body 10 and the second casing body 20. In addition, as shown in FIG. 1, a first sensor 91 for detecting an opening state and a closing state by the rotation of the second casing body 20 with respect to the first casing body 10 using the hinge mechanism 40 is interposed between the first casing body 10 and the second casing body 20. The first sensor 91 monitors the switch between the standby mode and the first mode. As the first sensor 91, any one of an electric contact type sensor, an optical type sensor, a mechanical switching type sensor and a magnetic switching type sensor may be used.

The sliding mechanism 50 shown in FIG. 1 includes a guide groove 58 formed in the side end of one casing body (for example, the second casing body 20) and a protrusion 59 fitted into the guide groove 58 and formed on the side end of the other casing body (for example, the third casing body 30), as shown in FIG. 3B. In the guide groove 58, the electrical connection between one casing body and the other casing body is performed. A stopper (not shown) for defining an allowable sliding range in the sliding mechanism 50 is formed between the second casing body 20 and the third casing body 30. A lock mechanism (not shown) for preventing the third casing body 30 from being carelessly moved to one side 1a. In addition, as shown in FIG. 1, a second sensor 92 for detecting a state in which the second casing body 20 and the third casing body 30 overlap with each other and a state in which the third casing body 30 is slidably moved to one side 1a with respect to the second casing body 20 using the guide groove 58 is interposed between the second casing body 20 and the third casing body 30. The second sensor 92 monitors the switch between the first mode and the second mode. As the second sensor 92, any one of an electric contact type sensor, an optical type sensor, a mechanical switching type sensor and a magnetic switching type sensor may be used.

### Configuration Example of Mode Controller

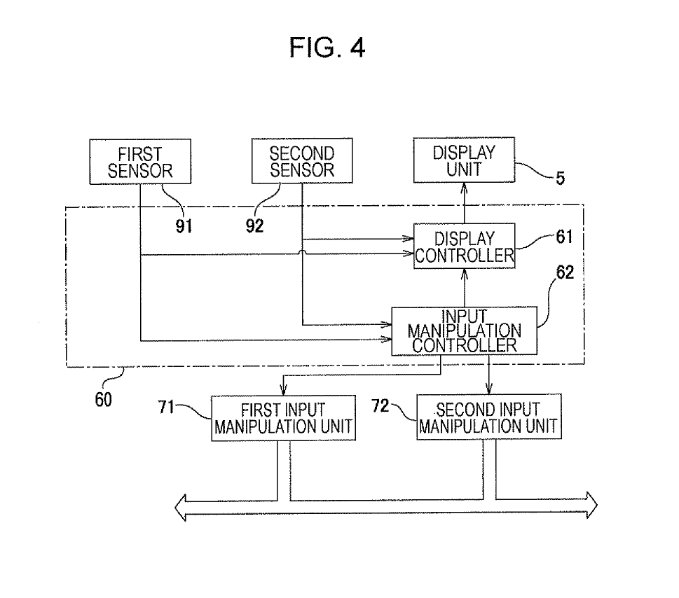

FIG. 4 is a block diagram showing the configuration of a mode controller included in the electronic apparatus 1 according to the invention.

In the electronic apparatus 1 according to the present embodiment, the mode controller 60 shown in FIG. 4 is included in the first casing body 10. In the present embodiment, the mode controller 60 includes a display controller 61 for controlling a display operation of the display unit 5 and an input manipulation controller 62 for controlling the first input manipulation unit 71 and the second input manipulation unit 72. The result of monitoring the switch between the standby mode and the first mode by the first sensor 91 is input to the display controller 61 and the input manipulation controller 62. Accordingly, the display controller 61 turns off the display unit 5 in the standby mode and automatically turns on the display unit 5 in the first mode such that the vertical long display shown in FIG. 2A is performed. The input manipulation controller 62 turns off the first input manipulation unit 71 and the second input manipulation unit 72 in the standby mode and sets the operation of the first input manipulation unit 71 to the standby state in the first mode. The input manipulation controller 62 turns off the second input manipulation unit 72 in the first mode.

The result of monitoring the switch between the first mode and the second mode by the second sensor 92 is also input to the display controller 61 and the input manipulation controller 62. Accordingly, when the first mode is switched to the second mode, the display controller 61 automatically switches the display of the display unit 5 from the vertically long display shown in FIG. 2A to the horizontally long display shown in FIG. 2B, and displays a selection screen of an application, which is expected to be used in the second mode, in the display unit 5. When the second mode is switched to the first mode, the display controller 61 automatically switches the display of the display unit 5 from the horizontally long display shown in FIG. 2B to the vertically long display shown in FIG. 2A. The input manipulation controller 62 sets both the first input manipulation unit 71 and the second input manipulation unit 72 to an input standby state in the second mode.

### Main Effect of Present Embodiment

As described above, in the electronic apparatus 1 of the present embodiment, in the first mode, the first input manipulation unit 71 is positioned on one side 1a of the display unit 5 for displaying the information, and an image display in which the first input manipulation unit 71 is positioned on the lower side of the display unit 5 is performed. In the present embodiment, the second mode in which the first input manipulation unit 71 and the second input manipulation unit 72 are positioned on the both sides of the display unit 5 is realized. In the second mode, an image display in which the first input manipulation unit 71 and the second input manipulation unit 72 are positioned on the left and right sides of the display unit is performed. Accordingly, in the second mode, the first input manipulation unit 71 and the second input manipulation unit 72 can be manipulated by the both hands of the user while viewing the image displayed by the display unit 5 and thus the manipulation property when the game function is used is excellent.

In the present embodiment, the plurality of casing bodies include the first casing body 10 in which the first input manipulation unit 71 is formed on the surface thereof, the second casing body 20 in which the second input manipulation unit 72 is formed on the surface thereof, and the third casing body 30 in which the display unit 5 is formed on the surface thereof. In the first mode, the third casing body 30 exposes the first input manipulation unit 71 in the first mode and completely overlaps with the second casing body 20 so as to cover the surface of the second input manipulation unit 72. Since the third casing body 30 covers the surface of the second casing body 20 in the first mode, the size of the electronic apparatus 1 in the first mode may be small.

In the present embodiment, since the first casing body 10 and the second casing body 20 overlap with the third casing body 30 in the thickness direction in the standby mode, the size of the electronic apparatus 1 in the standby state can be minimized.

### Embodiment 2

FIGS. 5A, 5B and 5C are views showing the shapes of an electronic apparatus 1 according to Embodiment 2 of the invention in a standby mode, a first mode and a second mode. Since the basic configuration of the electronic apparatus 1 of the present embodiment is equal to that of Embodiment 1, portions having the same functions are denoted by the same reference numerals and the detailed description thereof will be omitted.

The electronic apparatus 1 shown in FIGS. 5A, 5B and 5C includes various functions such as a communication function, a TV telephone function, a camera function, a video filming/displaying function, a game function, a music play function, and a schedule function, similar to Embodiment 1. By relatively moving these casing bodies which are slidably connected to each other, the standby mode shown in FIG. 5A, the first mode shown in FIG. 5B and the second mode shown in FIG. 5C are executed. Among these modes, in the first mode shown in FIG. 5B, a first input manipulation unit 71 is positioned on one side 1a of a display unit 5 and, in the second mode shown in FIG. 5C, the first input manipulation unit 71 and a second input manipulation unit 72 is positioned on the both sides of the display unit 5. In correspondence with the switch of the mode, in the display unit 5, as shown in FIG. 2A, an image display in which the first input manipulation unit 71 is positioned on a lower side of the display unit 5 is performed in the first mode and, as shown in FIG. 2B, an image display in which the first input manipulation unit 71 and the second input manipulation unit 72 are positioned on the left and right sides of the display unit 5 is performed in the second mode.

In order to realize these modes, in the present embodiment, three casing bodies including a first casing body 10, a second casing body 20 and a third casing body 30 are used.

First, in the present embodiment, the three casing bodies include the first casing body 10 in which the first input manipulation unit 71 is formed on the end of one side 1a of the surface thereof, the second casing body 20 in which the second input manipulation unit 72 is formed on the surface thereof, and the third casing body 30 in which the display unit 5 is formed on the substantially whole surface thereof. The first casing body 10 is connected to the third casing body 30 on the rear surface of the third casing body 30 via a first sliding mechanism 51 and the second casing body 20 is connected to the third casing body 30 on the rear surface of the third casing body 30 via a second sliding mechanism 52.

The third casing body 30 has a size which is equal to the sum of the size of the first casing body 10 and the size of the second casing body 20. In the standby mode shown in FIG. 5A, the first casing body 10 and the second casing body 20 overlap with the third casing body 30 in parallel with the third casing body 30 such that the surfaces thereof face the rear surface of the third casing body 30.

The switch from the standby mode to the first mode shown in FIG. 5B is performed by sliding only the first casing body 10 to one side 1a of the third casing body 30 by the first sliding mechanism 51 and exposing the first input manipulation unit 71 formed on the end of one side 1a of the surface of the first casing body 10. When an operation opposite to this operation is performed, the switch from the first mode to the standby mode is performed.

The switch from the first mode to the second mode shown in FIG. 5C is performed by sliding the second casing body 20 to the other side 1b of the third casing body 30 by the second sliding mechanism 52 and exposing the second input manipulation unit 72 formed on the surface of the second casing body 20. When an operation opposite to this operation is performed, the switch from the second mode to the first mode is performed.

By employing this configuration, the first sliding mechanism 51 and the second sliding mechanism 52 may be configured by the guide groove 58 formed in the side end of one casing body and the protrusion 59 fitted into the guide groove 58 and formed on the side end of the other casing body as described with reference to FIG. 3B. In the guide groove 58, the electrical connection between the two casing bodies is performed. A stopper or a lock mechanism (not shown) is formed between the first casing body 10 and the third casing body 30 and between the second casing body 20 and the third casing body 30, using the first sliding mechanism 51 and the second sliding mechanism 52. In addition, as shown in FIG. 5, a first sensor 91 for detecting a state in which the first casing body 10 overlaps with the third casing body 30 and a state in which the first casing body is slidably moved using the first sliding mechanism 51 is interposed between the first casing body 10 and the third casing body 30. The first sensor 91 monitors the switch between the standby mode and the first mode. In addition, as shown in FIG. 5, a second sensor 92 for detecting a state in which the second casing body 20 overlaps with the third casing body 30 and a state in which the second casing body is slidably moved using the second sliding mechanism 52 is interposed between the second casing body 20 and the third casing body 30. The second sensor 92 monitors the switch between the first mode and the second mode. In the present embodiment, the mode controller 60 described with reference to FIG. 4 in Embodiment 1 is included in the first casing body 10. On the basis of the monitoring results of the first sensor 91 and the second sensor 92, the display controller 61 and the input manipulation controller 62 control the display unit 5, the first input manipulation unit 71 and the second input manipulation unit 72.

As described above, in the electronic apparatus 1 of the present embodiment, similar to Embodiment 1, in the first mode, the first input manipulation unit 71 is positioned on one side 1a of the display unit 5 for displaying the information, and an image display in which the first input manipulation unit 71 is positioned on the lower side of the display unit 5 is performed. In the present embodiment, the second mode in which the first input manipulation unit 71 and the second input manipulation unit 72 are positioned on the both sides of the display unit 5 is realized. In the second mode, an image display in which the first input manipulation unit 71 and the second input manipulation unit 72 are positioned on the left and right sides of the display unit is performed. Accordingly, in the second mode, the first input manipulation unit 71 and the second input manipulation unit 72 can be manipulated by the both hands of the user while viewing the image displayed by the display unit 5 and thus the manipulation property when the game function is used is excellent, similar to Embodiment 1.

### Embodiment 3

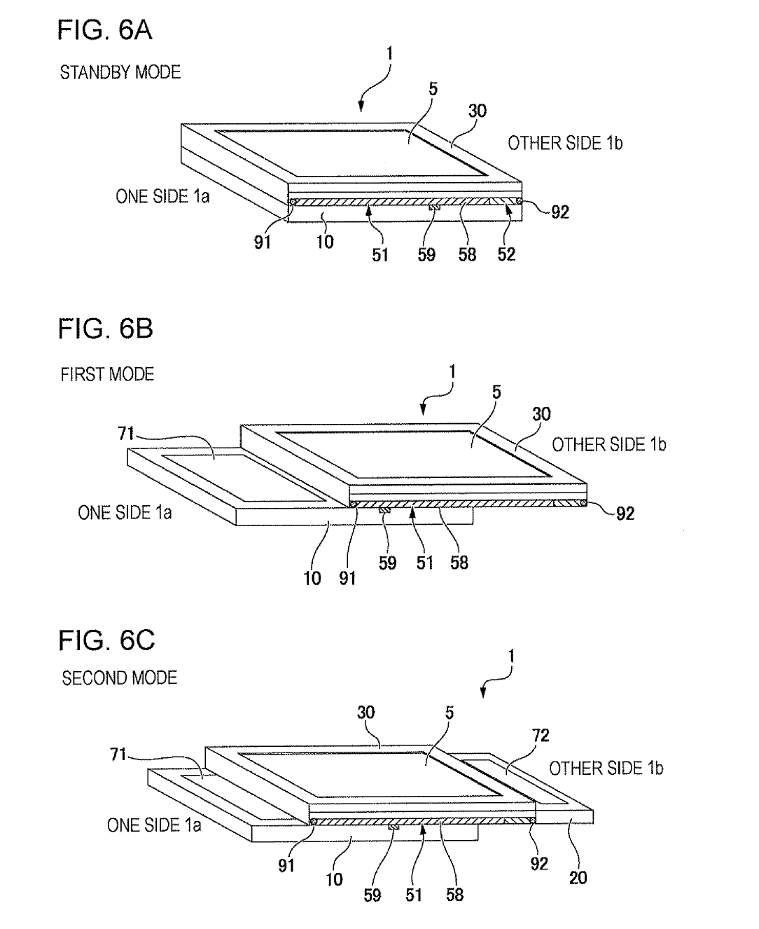

FIGS. 6A, 6B and 6C are views showing the shapes of an electronic apparatus 1 according to Embodiment 3 of the invention in a standby mode, a first mode and a second mode. Since the basic configuration of the electronic apparatus 1 of the present embodiment is equal to that of Embodiments 1 and 2, portions having the same functions are denoted by the same reference numerals and the detailed description thereof will be omitted.

The electronic apparatus 1 shown in FIGS. 6A, 6B and 6C includes various functions such as a communication function, a TV telephone function, a camera function, a video filming/displaying function, a game function, a music play function, and a schedule function, similar to Embodiments 1 and 2. By relatively moving these casing bodies which are slidably connected to each other, the standby mode shown in FIG. 6A, the first mode shown in FIG. 6B and the second mode shown in FIG. 6C are executed. Among these modes, in the first mode shown in FIG. 6B, a first input manipulation unit 71 is positioned on one side 1a of a display unit 5 for displaying information and, in the second mode shown in FIG. 6C, the first input manipulation unit 71 is positioned on one side 1a of the display unit 5 and a second input manipulation unit 72 is positioned on the other side 1b of the display unit 5. In correspondence with the switch of the mode, in the display unit 5, as shown in FIG. 2A, an image display in which the first input manipulation unit 71 is positioned on a lower side of the display unit 5 is performed in the first mode and, as shown in FIG. 2B, an image display in which the first input manipulation unit 71 and the second input manipulation unit 72 are positioned on the left and right sides of the display unit 5 is performed in the second mode.

In order to realize these modes, in the present embodiment, three casing bodies including a first casing body 10, a second casing body 20 and a third casing body 30 are used.

First, in the present embodiment, the three casing bodies include the first casing body 10 in which the first input manipulation unit 71 is formed on the end of one side 1a of the surface thereof the second casing body 20 in which the second input manipulation unit 72 is formed on the end of the other side 1b of the surface thereof, and the third casing body 30 in which the display unit 5 is formed on the substantially whole surface thereof. The first casing body 10 has the substantially same size as the third casing body 30, and the second casing body 20 has a size smaller than that of the third casing body 30 and a thickness smaller than that of the third casing body 30. A concave portion which is opened in the end of the other side 1b so as to receive the second casing body 20 is formed in the lower surface of the third casing body 30. The first casing body 10 is connected to the third casing body 30 on the rear surface of the third casing body 30 via a first sliding mechanism 51 and the second casing body 20 is connected to the third casing body 30 in a state of being received in the third casing body 30 via a second sliding mechanism 52.

In the electronic apparatus 1 having the above-described configuration, in the standby mode shown in FIG. 6A, the first casing body 10 provided on the rear surface of the third casing body 30 and the second casing body 20 is received in the third casing body 30.

The switch from the standby mode to the first mode shown in FIG. 6B is performed by relatively sliding only the first casing body 10 to one side 1a of the third casing body 30 by the first sliding mechanism 51 and exposing the first input manipulation unit 71 formed on the end of one side 1a of the surface of the first casing body 10. When an operation opposite to this operation is performed, the switch from the first mode to the standby mode is performed.

The switch from the first mode to the second mode shown in FIG. 6C is performed by sliding the second casing body 20 from the third casing body 30 to the other side 1b by the second sliding mechanism 52 and exposing the second input manipulation unit 72 formed on the end of the other side 1b of the surface of the second casing body 20. When an operation opposite to this operation is performed, the switch from the second mode to the first mode is performed.

By employing this configuration, the first sliding mechanism 51 and the second sliding mechanism 52 may be configured by the guide groove 58 formed in the side end of one casing body and the protrusion 59 fitted into the guide groove 58 and formed on the side end of the other casing body as described with reference to FIG. 3B. In the guide groove 58, the electrical connection between the two casing bodies is performed. A stopper or a lock mechanism (not shown) is formed between the first casing body 10 and the third casing body 30 and between the second casing body 20 and the third casing body 30, using the first sliding mechanism 51 and the second sliding mechanism 52. In addition, as shown in FIG. 6, a first sensor 91 for detecting a state in which the first casing body 10 overlaps with the third casing body 30 and a state in which the first casing body is slidably moved using the first sliding mechanism 51 is interposed between the first casing body 10 and the second casing body 20. The first sensor 91 monitors the switch between the standby mode and the first mode. In addition, as shown in FIG. 6, a second sensor 92 for detecting a state in which the second casing body 20 overlaps with the third casing body 30 and a state in which the second casing body is slidably moved using the second sliding mechanism 52 is interposed between the second casing body 20 and the third casing body 30. The second sensor 92 monitors the switch between the first mode and the second mode. In the present embodiment, the mode controller 60 described with reference to FIG. 4 in Embodiment 1 is included in the first casing body 10. On the basis of the monitoring results of the first sensor 91 and the second sensor 92, the display controller 61 and the input manipulation controller 62 control the display unit 5, the first input manipulation unit 71 and the second input manipulation unit 72.

As described above, in the electronic apparatus 1 of the present embodiment, similar to Embodiments 1 and 2, in the first mode, the first input manipulation unit 71 is positioned on one side 1a of the display unit 5 for displaying the information, and an image display in which the first input manipulation unit 71 is positioned on the lower side of the display unit 5 is performed. In the present embodiment, the second mode in which the first input manipulation unit 71 and the second input manipulation unit 72 are positioned on the both sides of the display unit 5 is realized. In the second mode, an image display in which the first input manipulation unit 71 and the second input manipulation unit 72 are positioned on the left and right sides of the display unit is performed. Accordingly, in the second mode, the first input manipulation unit 71 and the second input manipulation unit 72 can be manipulated by the both hands of the user while viewing the image displayed by the display unit 5 and thus the manipulation property when the game function is used is excellent, similar to Embodiment 1.

### Embodiment 4

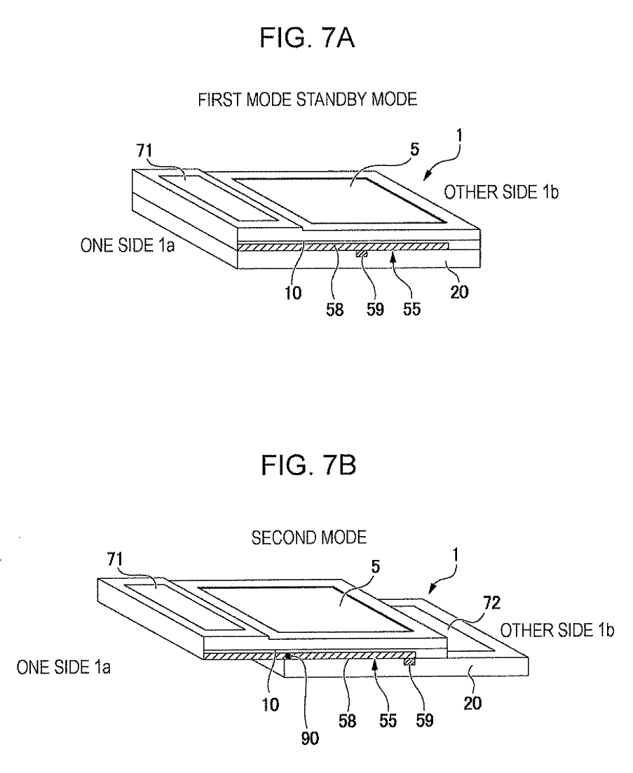

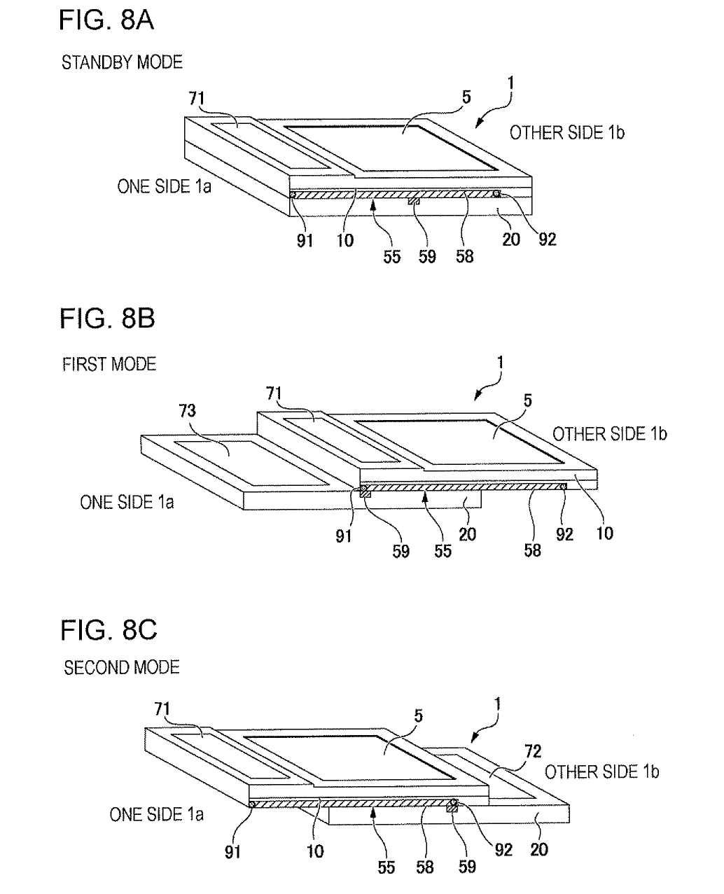

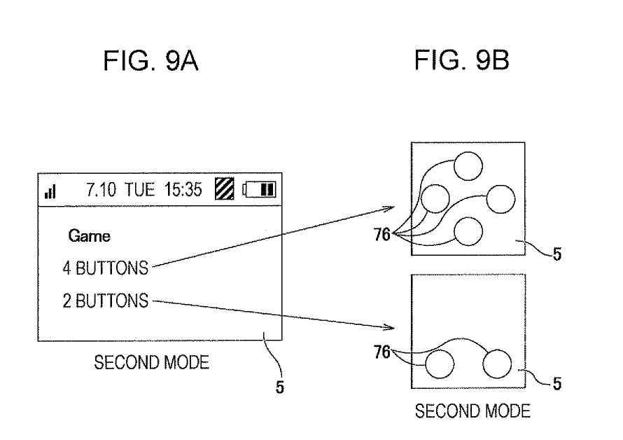

FIGS. 7A and 73 are views showing the shapes of an electronic apparatus 1 according to Embodiment 4 of the invention in a first mode and a second mode. Since the basic configuration of the electronic apparatus 1 of the present embodiment is equal to that of Embodiment 1, portions having the same functions are denoted by the same reference numerals and the detailed description thereof will be omitted.

The electronic apparatus 1 shown in FIGS. 7A and 7B includes various functions such as a communication function, a TV telephone function, a camera function, a video filming/displaying function, a game function, a music play function, and a schedule function, similar to Embodiment 1. By relatively moving these casing bodies which are slidably connected to each other, the first mode shown in FIG. 7A and the second mode shown in FIG. 7B are executed. Of these modes, in the first mode shown in FIG. 7A, a first input manipulation unit 71 is positioned on one side 1a of a display unit 5 for displaying information and, in the second mode shown in FIG. 7B, the first input manipulation unit 71 is positioned on one side 1a of the display unit 5 and a second input manipulation unit 72 is positioned on the other side 1b of the display unit 5. In correspondence with the switch of the mode, in the display unit 5, as shown in FIG. 2A, an image display in which the first input manipulation unit 71 is positioned on a lower side of the display unit 5 is performed in the first mode and, as shown in FIG. 2B, an image display in which the first input manipulation unit 71 and the second input manipulation unit 72 are positioned on the left and right sides of the display unit 5 is performed in the second mode.

In order to realize these modes, in the present embodiment, unlike Embodiments 1 to 3, two casing bodies including a first casing body 10 and a second casing body 20 are used.

First, in the present embodiment, as the two casing body, the first casing body 10, in which the first input manipulation unit 71 and the display unit 5 are respectively formed in the region of one side 1a and the region of the other side 1b of the surface thereof, and the second casing body 20 in which the second input manipulation unit 72 is formed on the end of the other side 1b of the surface thereof are included. The second casing body 20 is connected to the first casing body 10 on the rear surface of the first casing body 10 via a sliding mechanism 55. The first casing body 10 and the second casing body 20 have the substantially same size.

In the electronic apparatus 1 having the above-described configuration, in the first mode shown in FIG. 7A, the second casing body 20 is arranged on the rear surface of the first casing body 10 so as to completely overlap with the first casing body. This state is the same in the standby mode and, when an input manipulation to the first input manipulation unit 71 is performed, the standby mode is automatically switched to the first mode.

The switch from the first mode to the second mode shown in FIG. 7B is performed by relatively sliding the second casing body 20 to the other side 1b of the first casing body 10 by the sliding mechanism 55 and exposing the second input manipulation unit 72 formed on the end of the other side 1b of the surface of the second casing body 20. When an operation opposite to this operation is performed, the switch from the second mode to the first mode is performed.

By employing this configuration, the sliding mechanism 55 may be configured by the guide groove 58 formed in the side end of one casing body and the protrusion 59 fitted into the guide groove 58 and formed on the side end of the other casing body as described with reference to FIG. 3B. In the guide groove 58, the electrical connection between the two casing bodies is performed. A stopper or a lock mechanism (not shown) is formed between the first casing body 10 and the second casing body 20, using the sliding mechanism 55. In addition, as shown in FIG. 7, a sensor 90 for detecting a state in which the second casing body 20 overlaps with the first casing body 10 and a state in which the second casing body is slidably moved using the sliding mechanism 55 is interposed between the first casing body 10 and the second casing body 20. The sensor 90 monitors the switch between the first mode and the second mode. In the present embodiment, the same mode controller as the mode controller 60 described with reference to FIG. 4 in Embodiment 1 is included in the first casing body 10. On the basis of the monitoring result of the sensor 90, the display controller 61 and the input manipulation controller 62 control the display unit 5, the first input manipulation unit 71 and the second input manipulation unit 72.

As described above, in the electronic apparatus 1 of the present embodiment, similar to Embodiment 1 in the first mode, the first input manipulation unit 71 is positioned on one side 1a of the display unit 5 for displaying the information, and an image display in which the first input manipulation unit 71 is positioned on the lower side of the display unit 5 is performed. In the present embodiment, the second mode in which the first input manipulation unit 71 and the second input manipulation unit 72 are positioned on the both sides of the display unit 5 is realized. In the second mode, an image display in which the first input manipulation unit 71 and the second input manipulation unit 72 are positioned on the left and right sides of the display unit is performed. Accordingly, in the second mode, the first input manipulation unit 71 and the second input manipulation unit 72 can be manipulated by the both hands of the user while viewing the image displayed by the display unit 5 and thus the manipulation property when the game function is used is excellent, similar to Embodiment 1.

In the present embodiment, since the above modes can be executed by the two casing bodies (the first casing body 10 and the second casing body 20), it is possible to accomplish slimness and light weight of the electronic apparatus 1, compared with Embodiments 1 to 3.

### Embodiment 5

FIGS. 8A, 8B and 8C are views showing the shapes of an electronic apparatus 1 according to Embodiment 5 of the invention in a standby mode, a first mode and a second mode. Since the basic configuration of the electronic apparatus 1 of the present embodiment is equal to that of Embodiments 1 and 4, portions having the same functions are denoted by the same reference numerals and the detailed description thereof will be omitted.

The electronic apparatus 1 shown in FIGS. 8A, 8B and 8C includes various functions such as a communication function, a TV telephone function, a camera function, a video filming/displaying function, a game function, a music play function, and a schedule function, similar to Embodiment 1. By relatively moving these casing bodies which are slidably connected to each other, the standby mode shown in FIG. 8A, the first mode shown in FIG. 8B and the second mode shown in FIG. 5C are executed. Among these modes, in the first mode shown in FIG. 8B, a first input manipulation unit 71 is positioned on one side 1a of a display unit 5 for displaying information and, in the second mode shown in FIG. 8C, the first input manipulation unit 71 is positioned on one side 1a of the display unit 5 and a second input manipulation unit 72 is positioned on the other side 1b of the display unit 5. In correspondence with the switch of the mode, in the display unit 5, as shown in FIG. 2A, an image display in which the first input manipulation unit 71 is positioned on a lower side of the display unit 5 is performed in the first mode and, as shown in FIG. 2B, an image display in which the first input manipulation unit 71 and the second input manipulation unit 72 are positioned on the left and right sides of the display unit 5 is performed in the second mode.

In order to realize these modes, in the present embodiment, similar to Embodiment 4, two casing bodies including a first casing body 10 and a second casing body 20 are used.

First, in the present embodiment, as the two casing body, the first casing body 10, in which the first input manipulation unit 71 and the display unit 5 are respectively formed in the region of one side 1a and the region of the other side 1b of the surface thereof, and the second casing body 20 in which the second input manipulation unit 72 is formed on the end of the other side 1b of the surface thereof are included. On the surface of the second casing body 20, a third input manipulation unit 73 is formed on one side 1a with respect to the second input manipulation unit 72. The second casing body 20 is connected to the first casing body 10 on the rear surface of the first casing body 10 via a sliding mechanism 55. The first casing body 10 and the second casing body 20 have the substantially same size.

In the electronic apparatus 1 having the above-described configuration, in the first mode shown in FIG. 5A, the second casing body 20 is arranged on the rear surface of the first casing body 10 so as to completely overlap with the first casing body. The second input manipulation unit 72 and the third input manipulation unit 73 are covered by the first casing body 10.

The switch from the standby mode to the first mode shown in FIG. 5B is performed by relatively sliding the second casing body 20 to one side 1a of the first casing body 10 by the sliding mechanism 55. In the first mode, the first input manipulation unit 71 is positioned on one side 1a of the display unit 5 and the third input manipulation unit 73 is exposed at one side 1a of the first input manipulation unit 71. When an operation opposite to this operation is performed, the switch from the first mode to the standby mode is performed. The third input manipulation unit 73 is a pressing button type manipulation unit similar to the first input manipulation unit 71 and the second input manipulation unit 72, but the third input manipulation unit 73 may be configured as a display device attached with an input function, in which a touch panel is formed on the surface of a display device such as a liquid crystal device or an organic electroluminescence device, or an input device in which a touch panel overlaps with a sheet on which pressing buttons are printed.

The switch from the first mode to the second mode shown in FIG. 8C is performed by relatively sliding the second casing body 20 to the other side 1b of the first casing body 10 by the sliding mechanism 55 and exposing the second input manipulation unit 72 formed on the end of the other side 1b of the surface of the second casing body 20. In the second mode, the third input manipulation unit 73 is covered by the first casing body 10. When an operation opposite to this operation is performed, the switch from the second mode to the first mode is performed.

By employing this configuration, the sliding mechanism 55 may be configured by the guide groove 58 formed in the side end of one casing body and the protrusion 59 fitted into the guide groove 58 and formed on the side end of the other casing body as described with reference to FIG. 3B. In the guide groove 58, the electrical connection between the two casing bodies is performed. A stopper or a lock mechanism (not shown) is formed between the first casing body 10 and the second casing body 20, using the sliding mechanism 55. In addition, as shown in FIG. 8, a first sensor 91 for detecting a state in which the second casing body 20 overlaps with the first casing body 10 and a state in which the second casing body 20 is slidably moved to one side 1a using the sliding mechanism 55 is interposed between the first casing body 10 and the second casing body 20. The first sensor 91 monitors the switch between the first mode and the second mode. As shown in FIG. 8, a second sensor 92 for detecting a state in which the second casing body 20 overlaps with the first casing body 10 and a state in which the second casing body 20 is slidably moved to the other side 1b using the sliding mechanism 55 is interposed between the first casing body 10 and the second casing body 20. The second sensor 92 monitors the switch between the first mode and the second mode. In the present embodiment, the mode controller 60 described with reference to FIG. 4 in Embodiment 1 is included in the first casing body 10. On the basis of the monitoring results of the sensors 91 and 92, the display controller 61 and the input manipulation controller 62 control the display unit 5, the first input manipulation unit 71 and the second input manipulation unit 72.

As described above, in the electronic apparatus 1 of the present embodiment, similar to Embodiment 1 in the first mode, the first input manipulation unit 71 is positioned on one side 1a of the display unit 5 for displaying the information, and an image display in which the first input manipulation unit 71 is positioned on the lower side of the display unit 5 is performed. In the present embodiment, the second mode in which the first input manipulation unit 71 and the second input manipulation unit 72 are positioned on the both sides of the display unit 5 is realized. In the second mode, an image display in which the first input manipulation unit 71 and the second input manipulation unit 72 are positioned on the left and right sides of the display unit is performed. Accordingly, in the second mode, the first input manipulation unit 71 and the second input manipulation unit 72 can be manipulated by the both hands of the user while viewing the image displayed by the display unit 5 and thus the manipulation property when the game function is used is excellent, similar to Embodiment 1.

In the present embodiment, similar to Embodiment 4, since the above modes can be executed by the two casing bodies (the first casing body 10 and the second casing body 20), it is possible to accomplish slimness and light weight of the electronic apparatus 1, compared with Embodiments 1 to 3.

In the present embodiment, since the third input manipulation unit 73 is exposed at one side 1a of the first manipulation unit when the standby mode is switched to the first mode, only the number of buttons necessary for the second mode are required with respect to the first input manipulation unit 71. Therefore, it is possible to downsize the first input manipulation unit 71.

### Modified Example of Embodiments 1 to 5

FIGS. 9A and 9B are views showing a selection screen of pressing buttons displayed by the display unit 5 and the pressing buttons displayed by the selection, in an electronic apparatus 1 according to a modified example of Embodiments 1 to 5 of the invention.

Although both the first input manipulation unit 71 and the second input manipulation unit 72 are the pressing button type manipulation units in Embodiments 1 to 5, if the first input manipulation unit 71 or/and the second input manipulation unit 72 are configured by the display device attached with the input function, in which the touch panel is formed on the surface of the display device such as the liquid crystal device or the organic electroluminescence device and “Game” is selected as the selection image shown in FIG. 2B in the second mode, as shown in FIG. 9A, an image for selecting the shape of the pressing button may be displayed and, when a selection input manipulation of the first input manipulation unit 71 or/and second input manipulation unit 72 is performed with respect to the selected image, as shown in FIG. 9B, the number of manipulation buttons 76 displayed by the display device attached with the input function may be switched to two or four. According to this configuration, since an optimal number of pressing buttons 76 is displayed according to the types of the game used in the second mode, high convenience for use is achieved.

What is claimed is:

1. An electronic apparatus comprising:
a plurality of casing bodies which are connected to one another so as to be relatively moved,
a display unit for displaying information,
a first mode in which a first input manipulation unit is positioned on one side of the display unit, and
a second mode in which the first input manipulation unit is positioned on one side of the display unit and a second input manipulation unit is positioned on the other side of the display unit;
wherein the first mode and the second mode are switched by relatively moving the plurality of casing bodies, and
an image display in which the first input manipulation unit is positioned on a lower side of the display unit is performed in the first mode and an image display in which the first input manipulation unit and the second input manipulation unit are positioned on left and right sides of the display unit is performed in the second mode.

2. The electronic apparatus according to claim 1, wherein:
as the plurality of casing bodies, a first casing body in which the first input manipulation unit is formed on the surface thereof a second casing body in which the second input manipulation unit is formed on the surface thereof, and a third casing body in which the display unit is formed on the surface thereof are included,
in the first mode, the third casing body is arranged on the surface of the second casing body so as to overlap with the second casing body in a state in which the third casing body exposes the first input manipulation unit such that the surface of the second input manipulation unit is covered, and
when the first mode is switched to the second mode, the third casing body is moved to one side of the second casing body in a state in which the first input manipulation unit is exposed such that the surface of the second input manipulation unit is exposed.

3. The electronic apparatus according to claim 2, wherein the first casing body and the second casing body are moved relative to the third casing body such that switching is performed between a standby mode in which the first casing body and the second casing body overlap with the third casing body in a thickness direction and the first mode.

4. The electronic apparatus according to claim 3, wherein:
the end of the other side of the first casing body is connected to the end of one side of the second casing body via a hinge mechanism,
the third casing body is connected to the second casing body on the surface of the second casing body via a sliding mechanism,
in the standby mode, the second casing body and the third casing body overlap with the first casing body on the surface of the first casing body,
the switch from the standby mode to the first mode is performed by rotating the second casing body and the third casing body to the other side of the first casing body in a state of overlapping with each other by the hinge mechanism and exposing the surface of the first casing body and the surface of the third casing body, and
the switch from the first mode to the second mode is performed by sliding the third casing body toward the first casing body on the surface of the second casing body by the sliding mechanism so as to cover a portion of the surface of the first casing body and opening the other side of the surface of the second casing body.

5. The electronic apparatus according to claim 3, wherein:
the first casing body is connected to the third casing body on the rear surface of the third casing body via a first sliding mechanism,
the second casing body is connected to the third casing body on the rear surface of the third casing body via a second sliding mechanism,
in the standby mode, the first casing body and the second casing body overlap with the third casing body on the surface of the third casing body,
the switch from the standby mode to the first mode is performed by sliding only the first casing body to one side of the third casing body by the first sliding mechanism and exposing the surface of the first casing body, and
the switch from the first mode to the second mode is performed by sliding the second casing body to the other side of the third casing body by the second sliding mechanism and exposing the surface of the second casing body.

6. The electronic apparatus according to claim 3, wherein:
the first casing body is connected to the third casing body on the rear surface of the third casing body via a first sliding mechanism,
the second casing body is connected to the third casing body via a second sliding mechanism in a state of being received in the third casing body,
in the standby mode, the first casing body is arranged on the rear surface of the third casing body so as to overlap with the third casing body and the second casing body is received in the third casing body,
the switch from the standby mode to the first mode is performed by sliding only the first casing body to one side of the third casing body by the first sliding mechanism and exposing the surface of the first casing body, and
the switch from the first mode to the second mode is performed by sliding the second casing body to the other side of the third casing body by the second sliding mechanism and exposing the surface of the second casing body.

7. The electronic apparatus according to claim 1, wherein:
as the plurality of casing bodies, a first casing body in which the first input manipulation unit and the display unit are respectively formed in the region of one side and the region of the other side of the surface thereof and a second casing body in which the second input manipulation unit is formed on the surface thereof are included,
in the first mode, the first casing body is arranged on the second casing body so as to overlap with the second casing body and the second input manipulation unit is covered by the first casing body, and
when the first mode is switched to the second mode, the surface of the second casing body is exposed by relatively moving the first casing body to one side of the second casing body.

8. The electronic apparatus according to claim 7, wherein:
the second casing body is connected to the first casing body on the rear surface of the first casing body via a sliding mechanism, and
the switch from the first mode to the second mode is performed by sliding the second casing body to the other side of the first casing body by the sliding mechanism and exposing the surface of the second casing body.

9. The electronic apparatus according to claim 8, wherein:
a third input manipulation unit is formed on the surface of the second casing body in the region of one side of the second input manipulation unit,
in the standby mode, the second casing body overlaps with the first casing body in a thickness direction and the second input manipulation unit and the third input manipulation unit are covered by the first casing body, and
when the standby mode is switched to the first mode, the third input manipulation unit is exposed at one side of the first manipulation unit.

10. The electronic apparatus according to claim 1, further comprising a sensor which detects the switch between the first mode and the second mode,
wherein, on the basis of the detecting result of the sensor, the direction of an image displayed by the display unit is automatically switched between the first mode and the second mode.

11. The electronic apparatus according to claim 10, wherein the display unit displays a selection screen of an application, which is expected to be used in the second mode, in the second mode on the basis of the detecting result of the sensor.

12. The electronic apparatus according to claim 1, wherein:
at least one of the first input manipulation unit and the second input manipulation unit is configured by a display device attached with an input function, and
in the second mode, the shape of manipulation buttons displayed by the display device attached with the input function is switched on the basis of the input manipulation of the first input manipulation unit or/and the second input manipulation unit.
